(19) United States
(12) Patent Application Publication
(10) Pub. No.: US 2014/0288981 A1
(43) Pub. Date: Sep. 25, 2014

(54) METHODS AND SYSTEMS FOR TRAVEL-BASED INTERACTIONS

(71) Applicant: CONCUR TECHNOLOGIES, INC., Bellevue, WA (US)

(72) Inventors: Manish RAJKARNIKAR, Woodbury, MN (US); Sabirhusain Nazirhusain PATEL, Rosemount, MN (US); Andrew DOTSON, Minneapolis, MN (US); Michael FREDERICKS, Fairfax, VA (US)

(73) Assignee: CONCUR TECHNOLOGIES, INC., Bellevue, WA (US)

(21) Appl. No.: 14/219,745

(22) Filed: Mar. 19, 2014

Related U.S. Application Data
(60) Provisional application No. 61/803,586, filed on Mar. 20, 2013.
(60) Provisional application No. 61/803,588, filed on Mar. 20, 2013.

(51) Int. Cl. G06Q 10/02

(52) U.S. Cl. CPC G06Q 10/02
USPC 705/5

(57) ABSTRACT

Methods and systems comprising: receiving data; converting the data into machine readable data; extracting relevant data from the machine readable data; and populating a field in a report with the relevant data.

### CROSS-REFERENCE TO RELATED APPLICATIONS

This application claims the benefit of U.S. Provisional Application Nos. 61/803,586 filed Mar. 20, 2013 and 61/803,588 filed Mar. 20, 2013. All of the foregoing are incorporated by referenced in their entireties.

This application is related to U.S. patent application Ser. Nos. 14/213,550 filed Mar. 14, 2014; 14/213,523 filed Mar. 14, 2014; 14/188,414 filed Feb. 2, 2014; 14/060,960 filed Oct. 23, 2013; 14/036,320 filed Sep. 25, 2013; 13/842,913 filed Mar. 15, 2013; 13/830,410 filed Mar. 14, 20131 13/830,319 filed Mar. 14, 2013; 13/712,614 filed Dec. 12, 2012; 13/712,629 filed Dec. 12, 2012; 13/606,494 filed Sep. 7, 2012; 13/602,589 filed Sep. 4, 2012; 13/593,108 filed Aug. 23, 2012; 13/396,255, filed Feb. 14, 2012; 13/277,923 filed Oct. 20, 2011 (Now U.S. Pat. No. 8,620,750 issued Dec. 31, 2013); 13/277,916, filed Oct. 20, 2011; 13/117,303 filed May 27, 2011; 12/901,947 filed Oct. 11, 2010; 12/773,282 filed May 4, 2010; 12/755,127, filed Apr. 6, 2010 (now U.S. Pat. No. 8,140,361 issued Mar. 20, 2012); 11/763,562 filed Jun. 15, 2007; 11/159,398 filed Jun. 23, 2005 (now U.S. Pat. No. 7,974,892 issued Jul. 5, 2011); 10/373,096 filed Feb. 26, 2003 (now U.S. Pat. No. 7,720,702 issued May 18, 2010); 10/270,672, filed Oct. 16, 2002 (now abandoned); 09/784,836 filed Feb. 16, 2001 (now U.S. Pat. No. 7,401,029 issued Jul. 15, 2008); and 11/774,489, filed Jul. 6, 2007 (now abandoned) and U.S. Provisional Application Nos. 61/799,771 filed Mar. 15, 2013; 61/799,984 filed Mar. 15, 2013; 61/705,265 filed Sep. 25, 2012; 61/569,942 filed Dec. 13, 2011; 61/569,949 filed Dec. 13, 2011; 61/529,680 filed Aug. 31, 2011; 61/405,480 filed Oct. 21, 2010; 61/405,488 filed Oct. 21, 2010; 61/324,533, filed Apr. 15, 2010; 60/581,766, filed Jun. 23, 2004 and 60/329,281 filed Oct. 16, 2001. All of the foregoing are incorporated by reference in their entireties for all purposes.

### BRIEF DESCRIPTION OF THE DRAWINGS

FIG. 1 illustrates a system for alternative trip comparison and/or a system for queue-based interaction, according to an embodiment.

FIG. 2 illustrates a method for alternative trip comparison, according to an embodiment.

FIGS. 3 and 4, show how a user may create a travel request.

FIG. 5 shows how data for the separate proposals may be presented to the user in column form.

FIG. 6 illustrates a workflow process for how the compare and display modules may utilize the proposal information found by the TMC agent and determine how to display this information to the user.

FIG. 7 illustrates a method for queue-based interactions, according to an embodiment.

FIG. 8 is a network according to an embodiment of the invention.

FIG. 9 is a capture processing method according to an embodiment of the invention.

FIG. 10 is an email capture processing method according to an embodiment of the invention.

### DETAILED DESCRIPTION

Methods And Systems For Alternative Trip Comparisons

In some areas, a travel management company (TMC) system may be integrated with a pre-trip approval system, which may referred to as a travel and expense management system. Data may be exchanged between the two solutions so that the TMC may receive a structured trip request (TR), and the user (e.g., traveler, traveler's assistant who completes booking) may receive comprehensive trip options (e.g., air travel, train travel, rental car, hotel room, visa requests, loyalty subscriptions, insurance, taxi or car service, etc.). Such integration may offer various business benefits. The TMC may obtain additional information (e.g., allocations regarding which project, cost center, company department, clients, etc. will be responsible for paying for the TR expenses). The TMC may utilize information from the travel and expense management to determine how to optimize the traveler's experience at the least expensive cost (e.g., using loyalty programs, fee arrangements with certain vendors, etc.). The user may obtain comprehensive information in his TR (e.g., for approval, reporting, travel policy, pricing information)). For example, if a user has a TR that includes an upgrade to first class, this information may be useful because it may require a different approval workflow. This information is helpful to, for example, an employer so that the employer may be able to force the company policies to be obeyed.

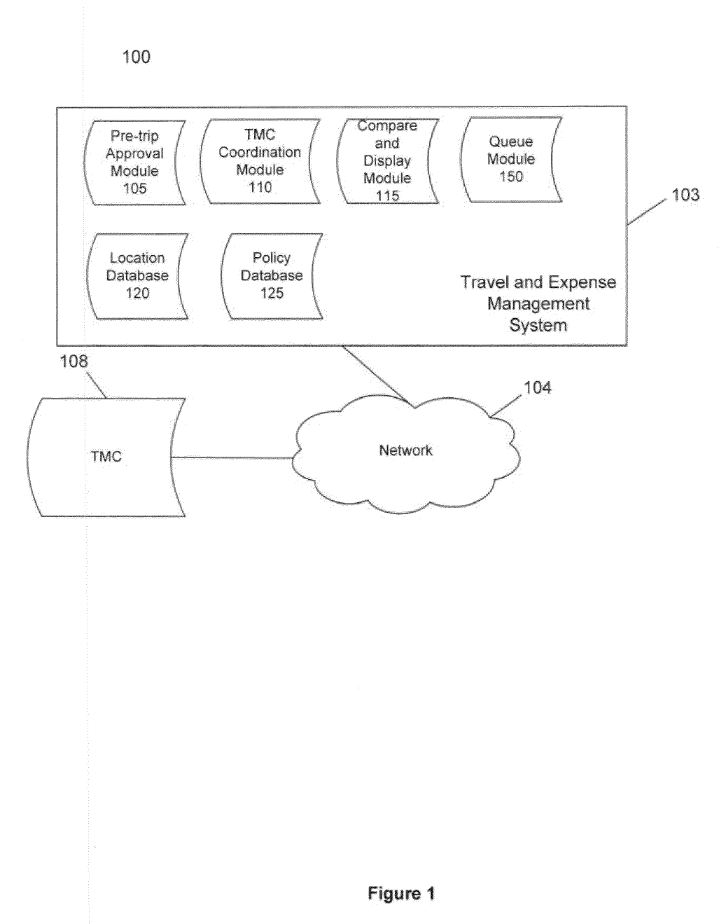

FIG. 1 illustrates a system 100 for alternative trip comparison, according to an embodiment. FIG. 1 comprises a travel and expense management system 103 which may communicate with a TMC 108 through a network 104, which may comprise the Internet or an intranet. The communication may be done using, for example, RESTful WebService technology (e.g., described in https://developer.concur.com/what-can-i-do-concur-connect, which is herein incorporated by reference), Axis Servelet technology, Comma Separation Values (CSV) technology, File Transfer Protocol (FTP) technology, or any other communication technology, or any combination thereof. Although this specification describe information being accessed by a TMC, in some embodiments, the TMC may pull information from the travel and expense management system, and in other embodiments, the travel and expense management system may push information to the TMC. In still other embodiments, both may occur, or the information exchanged between the two systems may be accessed using any technology available.

The travel and expense management system may comprise: a pre-trip approval module 105, a TMC coordination module 110, a compare and display module 115, a location database 120, a policy database 125, or any combination thereof. The travel and expense management system may also comprise any modules or perform any functions described in the applications incorporated by reference. The pre-trip approval module may communicate with the policy database to determine which workflow process to follow to obtain an approval for a certain item. The policy database may store the policies applicable to certain companies. The TMC coordination module may share any relevant information about TRs with the travel and expense management system. The compare and display module may communicate with the location database to determine how to display the options to the user.

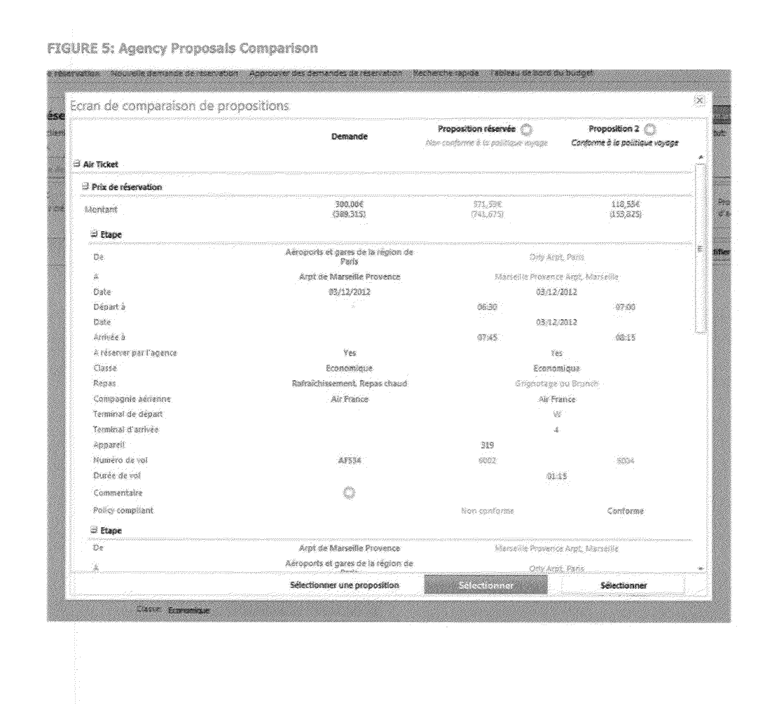

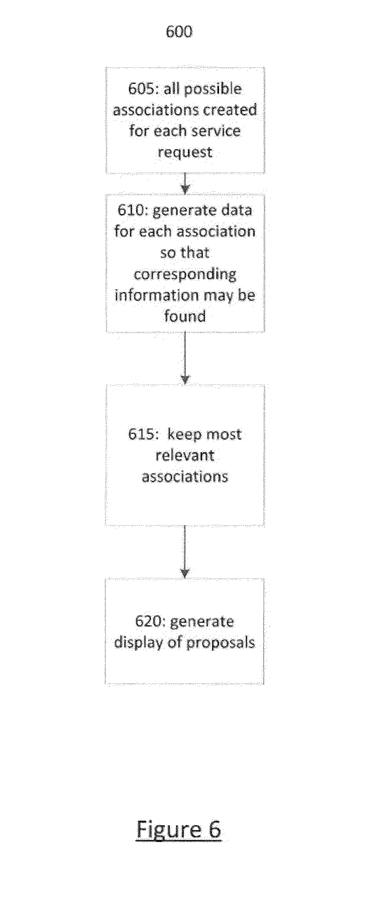

FIG. 6 illustrates a workflow process for how the compare and display modules may utilize the proposal information found by the TMC agent and determine how to display this information to the user. In 605, all possible associations (e.g., to, from, data, class, price) may be created for each service request and, if appropriate, each segment of each service request from the proposal. In 610, metadata may be generated for each association so that corresponding information may be easily found. This may comprise: segment type matching, the distance between two points (using the location database), the date and time between dates, etc. The associations may then be sorted by metadata to order the list by relevance. In 615, the most relevant associations are kept. In 620, the display may be generated according to the segment type (with, for example, the most important segment on the top) and by natural order if needed (e.g., in a multi-leg segment) starting with the request information and then the proposals, so that the proposal information is places nearby (e.g., on the side of), the request information. In one embodiment, the policy database may be accessed and any information which is found to not comply with a company's policy may be highlighted for the user, as also shown in FIG. 5.

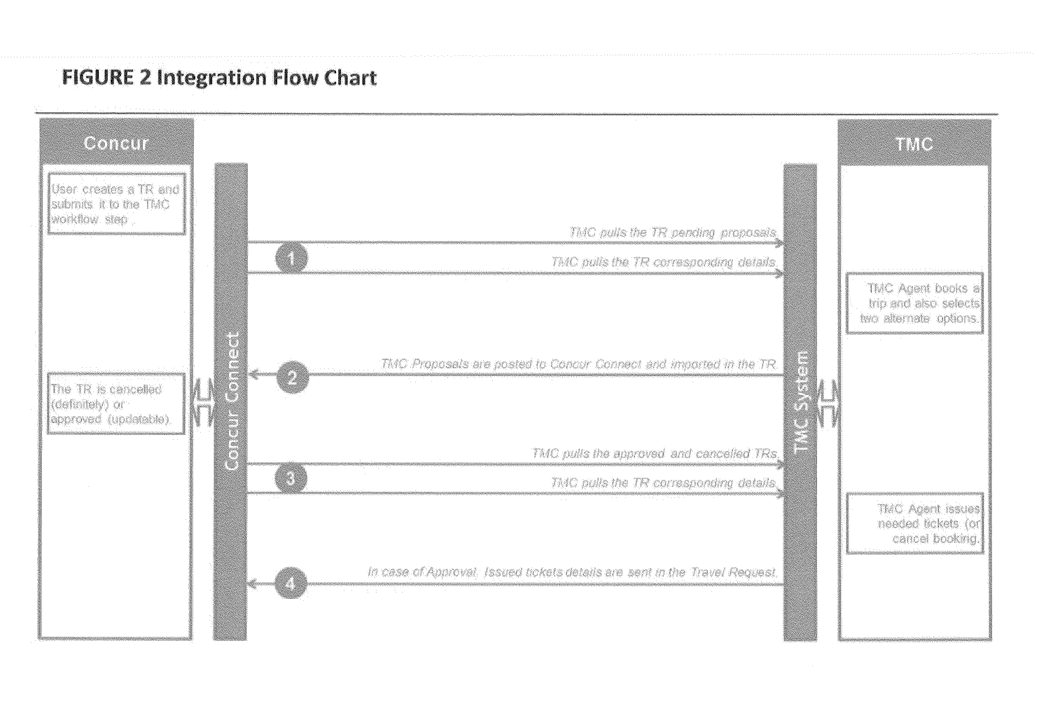

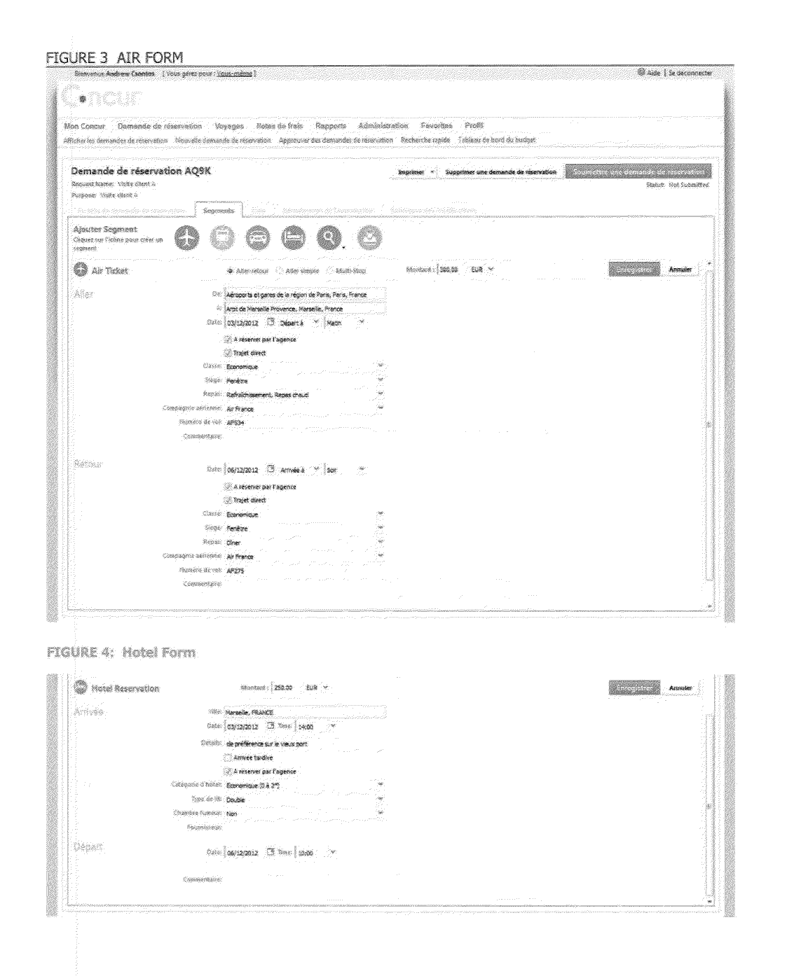

FIG. 2 illustrates a method for alternative trip comparison, according to an embodiment. In 1, as shown in FIGS. 3 and 4, a user may create a travel request (TR) with the needed travel needs (e.g., flight, car, train, etc. segments, hotel room, rental car) (e.g., using a travel and expense management application) and may submit it to a travel manager company (TMC) system (e.g., using HTML email, as an XML attachment, as an automated XML attachment if the TMC is set up to receive this data, etc.). The travel service may be flight segments, train segments, car rental, hotel, etc. The TMC agent may access the TR details (e.g., automatically If XML, manually if email) and determine what proposals (e.g., different flight options, difference hotel options) are available to the user. In 2, the TMC may post the proposals to the travel expense and management system and import the proposals into the TR. The posting of the proposals may be displayed according to the process described in FIG. 6, in one embodiment. The user then chooses a proposal, and if necessary, sends it for approval. The TR is then cancelled or approved. In 3, the TMC may access details regarding the booked, approved and cancelled TRs and determine what actions are necessary at that point. For example, If the trip option that was selected by the user has been approved, but is no longer available, the process of selecting a predetermined amount of alternative options (e.g., up to 2 or 3) may be repeated so that the user may choose another option based on what is currently available. The TMC agent will also have the information he needs to update the TR if necessary. In 4, in case of approval, the issued ticket details may be sent in the TR to the travel and expense management system. Thus, if there is an update (e.g., cancellation, change) the TR may be changed accordingly.

Agency proposals may be parsed by the travel and expense management system (e.g., using optical character recognition (OCR) technology to pull the data) and imported into the TR. The data may comprise geolocation information on the codes for the corresponding locations (e.g., airport codes, train station code), and, using location data to compute the distance to determine which locations correspond to which services request in the TR, compare that with the city (e.g., not airport code, train station code, etc.) provided by the customer. The travel and expense management system may then determine the travel legs by determining a location (.e.g., an airport with a certain code) must be near the city provided by the user. The system may also contact the expense database and the authorization request product in the expense database to access information from the user's initial TR and compare those points against the TMC proposals.

As shown in FIG. 5, data for the separate proposals may be presented to the user in column form. The travel and expense management system may tell if a proposal element is not in compliance (e.g., policy compliance) with the users request by highlighting that field. For example, if the user identifies they want a hotel under $200 a night, and the proposal is for $210 a night, that will show up highlighted or differentiated in some way (e.g., as bold or a different color).

If a requested element is the same for all the proposals, the system may illustrate this by presenting the rows for all the proposals merged into one cell. Once the proposals are available in the TR, the user may be notified. The user may review, compare and select his preferred proposal. It should be noted that the TR may be updated (e.g., add/update/cancel segments), so the above steps may be get repeated. The TR may be routed in the approval workflow until it is cancelled or approved. The TMC may access the approved TRs (e.g., orders) and/or cancelled TRs, including the segment details and other information in the TR. The TMC agent may respectively issue or cancel the corresponding tickets. The TMC may optionally post the booked trip, as a confirmation, in its “tickets issued” state.

Methods And Systems For Queue-Based Interactions

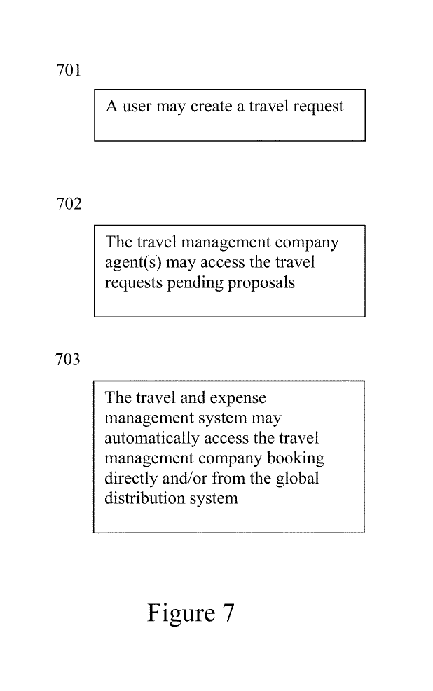

FIG. 6 also illustrates a system for queue-based interactions. In FIG. 6, the travel and expense management system 603 may also comprise a queue module 650, which may access a TR directly from a TMS and/or a GDS. FIG. 7 illustrates a method for queue-based interactions. In 701, the user may create a travel request (TR) with the needed information for a trip (e.g., flight, car rental, hotel room). In some embodiments, the user may submit the TR to the TMC system, which may be integrated with the travel and expense management system so that the TR is sent to the TMC automatically (e.g., no need to email, etc.).

In 702, the TMC agent may access the TRs pending proposals. A screen on the TMC system may show a TMC agent all the pending requests. The TMC may then directly manage the TR. The TMC agent may update the information and submit it to the GDS for booking The TMC agent may modify a field (e.g., the Request ID) to show the information has been sent to the travel and expense management system and/or to a GDS.

In 703, the travel and expense management system may automatically access the TMC booking directly and/or from the GDS. This process may save time by eliminating a need for the TMC to return the information to the travel and expense management system. In addition, if the information is only sent to the GDS, the TMC agent does not need to do any additional work other than what they already do by sending the information to the GDS. The travel and expense management system may reconcile the booking information from the GDS with the original requested information from the user using the request information. By automatically pulling the information from the GDS and reconciling it with the original request, the travel and expense management system may avoid, for example, having anyone manually enter the information, speeding up the process and avoiding errors. The travel and expense management system may then automatically notify the user the booking has been placed, allowing the user to send confirmation. The booking information may then be automatically sent to the user's manager for approval of the expense item prior to booking This may happen if there is a rule set up indicating that a particular user's approvals should be automatically sent to the manager(s) under certain conditions (e.g., under a certain amount). If this rule is set up, information from the policy database may be used to determine whether or not a request meets all the criteria for approval, and if so, the request will be sent directly to the manager for approval.

Methods And Systems for Capture Processing

Systems and methods described herein may capture and process data such as invoice data. For example, a buyer may receive an invoice from a seller via an email or other communication medium. In another example, a paper invoice may be received. The invoice may be captured and processed. Data contained within the invoice may be extracted for use and/or analysis. For example, the data may be added to an expense system to enable tracking, review, payment, or other activities. While the examples described herein are presented in the context of invoice tracking, the capture processing systems and methods may be used with other types of data as well.

Systems and methods described herein may comprise one or more computers. A computer may be any programmable machine or combination of programmable machines capable of performing arithmetic and/or logical operations. In some embodiments, computers may comprise processors, memories, data storage devices, and/or other commonly known or novel components. These components may be connected physically or through network or wireless links. Computers may also comprise software which may direct the operations of the aforementioned components. Computers may be referred to with terms that are commonly used by those of ordinary skill in the relevant arts, such as servers, PCs, mobile devices, routers, switches, data centers, and other terms. Computers may facilitate communications between users and/or other computers, may provide databases, may perform analysis and/or transformation of data, and/or perform other functions. It will be understood by those of ordinary skill that those terms used herein are interchangeable, and any computer capable of performing the described functions may be used. For example, though the term “server” may appear in the following specification, the disclosed embodiments are not limited to servers.

Computers may be linked to one another via a network or networks. A network may be any plurality of completely or partially interconnected computers wherein some or all of the computers are able to communicate with one another. It will be understood by those of ordinary skill that connections between computers may be wired in some cases (i.e. via Ethernet, coaxial, optical, or other wired connection) or may be wireless (i.e. via Wi-Fi, WiMax, or other wireless connection). Connections between computers may use any protocols, including connection oriented protocols such as TCP or connectionless protocols such as UDP. Any connection through which at least two computers may exchange data can be the basis of a network.

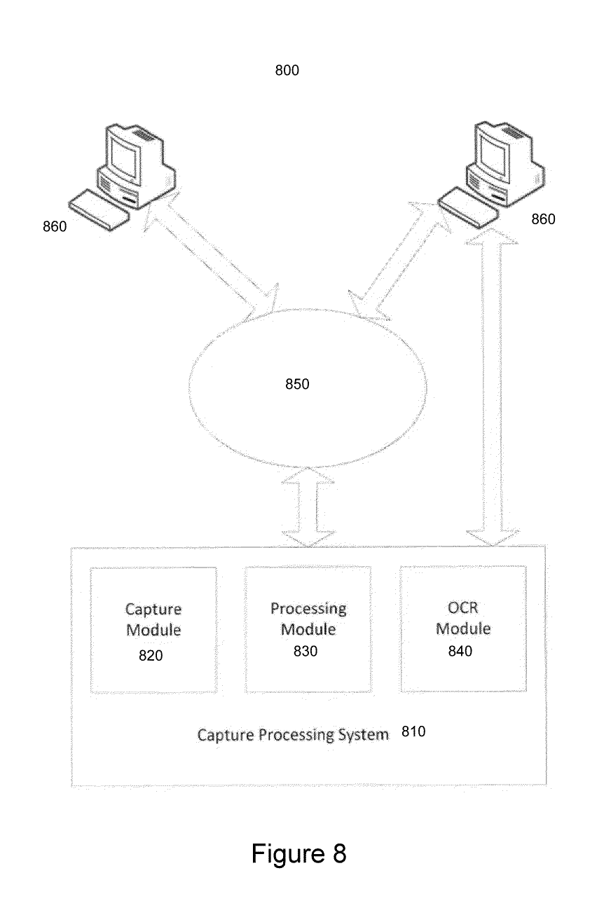

FIG. 8 is a network 800 according to an embodiment of the invention. The network may include a capture processing system 810 which may include one or more computers. The capture processing system 810 may include a capture module 820 which may receive an invoice, an optical character recognition (OCR) module 840 which may process the invoice to convert it to data which may be machine readable and/or editable, and a processing module 830 which may further process the converted data. The functions of these modules are described in greater detail below. Also note that in some cases, one or more of the modules may be elements of another computer system in communication with the capture processing system 810. For example, an OCR module 840 may be provided by a third party computer in some embodiments.

The capture processing system 810 may be connected to one or more networks 850, such as a public internet or private intranet, through which the capture processing system 810 may receive invoice data (for example via email). However, in some embodiments the capture processing system 810 may be a standalone system as well (for example, if all invoices are being entered from paper sources, there may be no need to receive invoices via email). The capture processing system 810 may also be directly connected to one or more other computers 860, through which the capture processing system may receive invoices. Also, other computers 860 may be in communication with the network 850 and may send invoice data to the capture processing system 810 via the network.

The capture processing system 810 may capture invoice data and may categorize and/or route the invoice for review and/or processing based on the captured data. The capture processing system 810 may gather information and context about invoices at multiple points in time. Thus, after a first invoice is captured and fields are populated a certain way, a second invoice captured may have similar fields automatically populated in a similar way. The OCR module 840 may process the captured invoice soon after the invoice is captured by the capture module 820, for example within a minute, so that the data may be made available to a user quickly. If a paper invoice is received, as those invoices are scanned and uploaded, the processing module 830 may choose any field known about the invoice for processing. For example, a processing department of a company might know that all invoices sent a particular PO box are for a specific department. They might know that all invoices received in the UK require VAT processing. They might know a specific batch is all US Dollars. The processing module 130 may gather one or more configurable fields of interest, such as fields related to any of the examples above. The processing module 830 may also gather information on email invoices such as the from: address or an image name that might indicate information about the invoice.

The processing module 830 may use information previously processed by the capture processing system 810 to help it achieve better accuracy. For example, words and phrases which may be known to be of interest by a user (e.g., VAT, PO, Department, GL Coding, etc.) may be detected by the OCR module 840. When the OCR module 840 sends invoice data including such words and phrases of interest to the processing module 830 for a first time, the processing module 830 may not already know to place the data associated with the words and phrases into an appropriate field in an expense report, for example. In some cases, this may be because a field for such words and phrases has not yet been created in the processing module 830. However, as users reviewing expense reports in the processing module 830 repeatedly place data associated with “PO” into an address field, for example, the processing module 830 may identify the association between “PO” and address. The processing module 830 may use this identified association to automatically populate a field with data related to the identified association in future processing (for example, populate an address field with “PO” related data). Likewise, if a new field is created and data associated with a certain word or phrase is placed into that field, the processing module 830 may place similar data into that field in a future processing step. The capture processing system 810 may also allow the fields to be configured and/or reconfigured by users so that the processing module 830's processing may be tailored to the requirements of a particular user or business.

In some cases, invoices and expense reports may be subject to the requirements of company policies. The processing module 830 may be configured to perform its processing based on applicable policies. For example, the processing module 830 may search for certain data in the OCR processed invoice based on a policy, the processing module 830 may populate certain fields in a report based on a policy, determine where invoices or expense reports may be routed for approval based on a policy, etc.

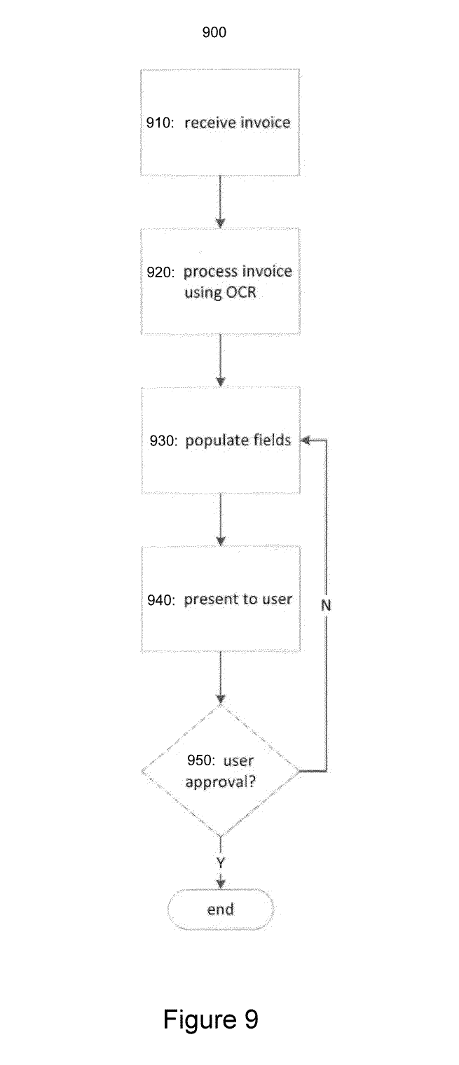

FIG. 9 is a capture processing method 900 according to an embodiment of the invention. In 910, the capture module 920 may receive an invoice. For example, this may be a paper invoice scanned into the capture processing system 910, an electronic invoice, or an invoice entered in some other way. (Note that electronic invoices are also discussed in greater detail below.) In 920, the OCR module 840 may receive the captured invoice from the capture module 820 and may perform OCR processing on the invoice. In 930, the processing module 830 may receive the OCR processed invoice from the OCR module 840 and may populate fields in an expense report or other dataset. In 940, the processing module 830 may present the report to a user for review. For example, the report may be displayed on a graphical user interface (GUI) on a user computer 860 in communication with the capture processing system 810 and/or a computer of the capture processing system 810 itself. In 950, the processing module 830 may receive user approval, and the process 900 may end with the data in the expense report being ready for further processing by the capture processing system 810 or some other system. For example, the expense report may be sent to an accounting computer or user and may be used to approve and/or pay the invoice. If the user does not approve in 950, the user may make changes to the fields and the processing module 830 may process these changes and populate the fields in 930. As noted above, the changes may include adding new fields and/or associating certain data with certain fields, so that future instances of the process 900 may automatically process the data in a manner similar to that suggested by the user.

The capture processing system 810 may capture invoice data received via email or some other electronic communications medium. The capture processing system 810 may be able to capture the invoice data whether the invoice is in a processing ready format (e.g., electronic data interchange (EDI)) or not. For example, a supplier may send an email with an image of an invoice to the capture processing system 810. This may be done as part of the ordinary course of business, as many suppliers they send an image of the invoice to their buyer. In such a case, an email address which is associated with the capture processing system 810 may be provided to suppliers as an address to which to send invoices. In other cases, an invoice may be forwarded by its recipient to the capture processing system 810. The invoices may be received via email, and the capture processing system 810 may identify a buyer for which the invoice is intended. For example, the capture module 820 may examine the email and detect identifying data in the email which may associate the email with a particular buyer. Once the buyer is known, the OCR module 840 may process the image to place its data in a computer readable format. The processing module 830 may then extract the invoice data from the OCR processed data. Multiple techniques may be used to determine the correct data to capture for the invoice. For example, techniques may include vendor lookups, invoice number formatting, PO number recognition, etc. The invoices may be processed through an automated workflow by the processing module 830, which may determine how much user verification needs to be done on the captured data. This automated workflow may allow the processing module 830 to verify that all data is correct and can be configured based on individual buyer interests. Once all data is captured and verified, it may be integrated into an invoice processing system, which may allow a buyer to approve and pay the invoice.

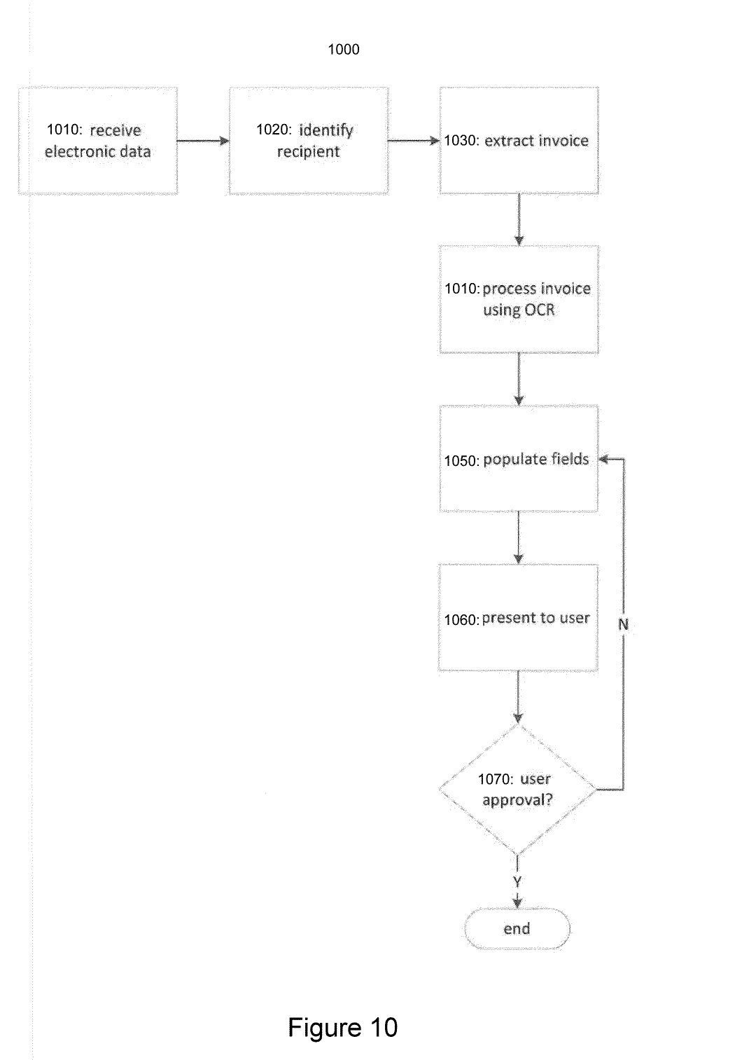

FIG. 10 is an email capture processing method 1000 according to an embodiment of the invention. In 1010, the capture module 820 may receive electronic data which may include an invoice. For example, the received data may be in the form of an email. An email address may have been linked to the capture processing system 810 and distributed to suppliers, so that invoices may be routinely sent to the capture processing system 810 by the suppliers. In 1020, the capture module 820 may examine the email and identify its intended recipient. For example, the capture module 820 may read the destination email address and determine a user, department, client, etc. associated with that email address, for example by looking the address up in a database. In 1030, the capture module 820 may extract an invoice from the electronic data. This invoice may be in any format. It may be included in the body of the email and/or it may be an attachment. In 1040, the OCR module 840 may receive the captured invoice from the capture module 820 and may perform OCR processing on the invoice. In 1050, the processing module 830 may receive the OCR processed invoice from the OCR module 840 and may populate fields in an expense report or other dataset. In 1060, the processing module 830 may present the report to a user for review. For example, the report may be displayed on a graphical user interface (GUI) on a user computer 860 in communication with the capture processing system 810 and/or a computer of the capture processing system 810 itself In 1070, the processing module 830 may receive user approval, and the process 1000 may end with the data in the expense report being ready for further processing by the capture processing system 810 or some other system. For example, the expense report may be sent to an accounting computer or user and may be used to approve and/or pay the invoice. If the user does not approve in 1070, the user may make changes to the fields and the processing module 830 may process these changes and populate the fields in 1050. As noted above, the changes may include adding new fields and/or associating certain data with certain fields, so that future instances of the process 1000 may automatically process the data in a manner similar to that suggested by the user.

What is claimed is:

1. A method comprising:
performing processing associated with receiving, with a capture module in communication with a processor, data;
performing processing associated with converting, with an optical character recognition (OCR) module in communication with the capture module and the processor, the data into machine readable data;
performing processing associated with extracting, with a processing module in communication with the OCR module and the processor, relevant data from the machine readable data;
performing processing associated with populating, with the processing module, a field in a report with the relevant data;
performing processing associated with sending, with the processing module, the report to a user;
performing processing associated with receiving, with the processing module, a change to the field from the user; and
performing processing associated with populating, with the processing module, the field in the report with the change.
